(19) United States
(12) Patent Application Publication
(10) Pub. No.: US 2008/0163722 A1
(43) Pub. Date: Jul. 10, 2008

(54) Teeth disk

(76) Inventor: Douglas Chiang, Taichung (TW)

Correspondence Address: DOUGLAS CHIANG, 235 Chung - Ho, Box 8-24, Taipei, omitted

(21) Appl. No.: 11/649,311

(22) Filed: Jan. 4, 2007

(51) Int. Cl. F16H 1/00

(52) U.S. Cl. 74/640

(57) ABSTRACT

A teeth disk comprises one surface of the teeth disk having a plurality of recesses which do not penetrate through the teeth disk; and a bottom of each recess is formed as a stop. Each recess has a cambered shape which is arranged near an edge of the teeth disk. A plurality of teeth are formed along the edge of the teeth disk for engaging to a chain of a bicycle. The teeth disk has a ring structure with a hollow central hole for installing a crank. An inner edge of the central hole is protruded with a plurality of ears; and each ear has an ear hole for combining with a crank.

### FIELD OF THE INVENTION

The present invention relates to bicycle parts, and particularly to a teeth disk wherein the recesses in the teeth disk for receiving a crank of a bicycle do not penetrating through the body of the teeth disk so that the teeth disk has a concrete structure than the prior art.

### BACKGROUND OF THE INVENTION

In the prior art teeth disk of a bicycle, the teeth disk has a hollow central hole. A groove is arranged near the outer edge of the teeth disk. The central hole serves to assemble a spindle. The groove serves to combine with a crank. Furthermore a plurality of via holes are arranged on the teeth disk for reducing the weight of the teeth disk. The groove and via holes penetrate through the teeth disk.

However, in the prior art, since the via holes and groove penetrate through the teeth disk so that the structure of the teeth disk is weak and thus the teeth disk is easy to deform. Especially, in treading a great force is transferred to the treadle. And then the force is further transferred to the crank and then to the teeth disk so as to make the teeth disk deform. This will destroy the structure of the teeth disk and possibly accident is induced.

### SUMMARY OF THE INVENTION

Accordingly, the primary object of the present invention is to provide a teeth disk wherein the recesses in the teeth disk for receiving a crank of a bicycle do not penetrating through the body of the teeth disk so that the teeth disk has a concrete structure than the prior art.

To achieve above objects, the present invention provides a teeth disk which comprises one surface of the teeth disk having a plurality of recesses which do not penetrate through the teeth disk; a bottom of each recess is formed as a stop. Each recess has a cambered shape which is arranged near an edge of the teeth disk. A plurality of teeth are formed along the edge of the teeth disk for engaging to a chain of a bicycle. The teeth disk has a ring structure with a hollow central hole for installed with a crank. An inner edge of the central hole is protruded with a plurality of ears; each ear has an ear hole for combining with a crank.

The various objects and advantages of the present invention will be more readily understood from the following detailed description when read in conjunction with the appended drawing.

### BRIEF DESCRIPTION OF THE DRAWINGS

FIG. 1 is a schematic perspective view of the teeth disk of the present invention.

FIG. 2 is a lateral schematic view of the teeth disk of the present invention.

FIG. 3 is a cross sectional view along line AB of FIG. 2.

FIG. 4 is a schematic perspective view of the teeth disk of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

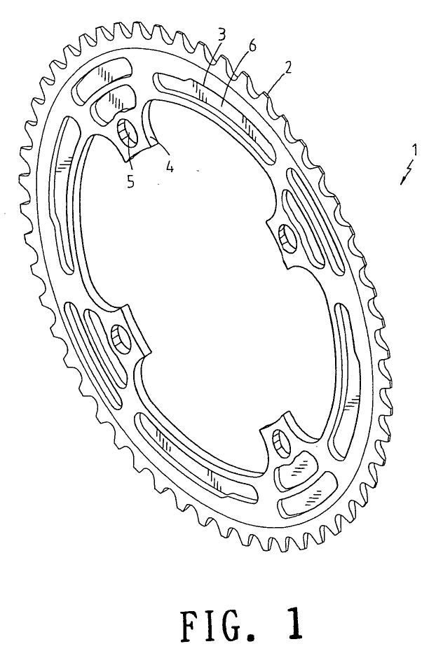

Referring to FIG. 1, the teeth disk 1 of the present invention is illustrated. The present invention has the following elements.

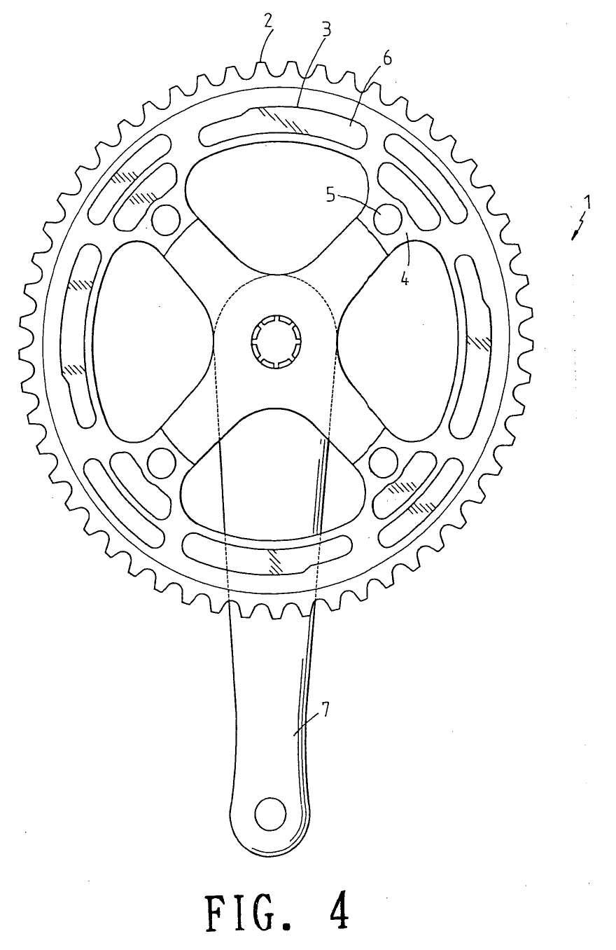

One surface of the teeth disk 1 is a flat plane (see FIG. 3), and another surface thereof has a plurality of recesses 3 which do not penetrate through the teeth disk 1. Each recess 3 has a cambered shape which is arranged near an edge of the teeth disk 1. A plurality of teeth 2 are formed along the edge of the teeth disk 1 for engaging to a chain of a bicycle (not shown). The teeth disk 1 has a ring structure with a hollow central hole. An inner edge of the central hole is protruded with four ears 4. Each ear 4 has an ear hole 5 for combining with a crank 7 of a bicycle (FIG. 4).

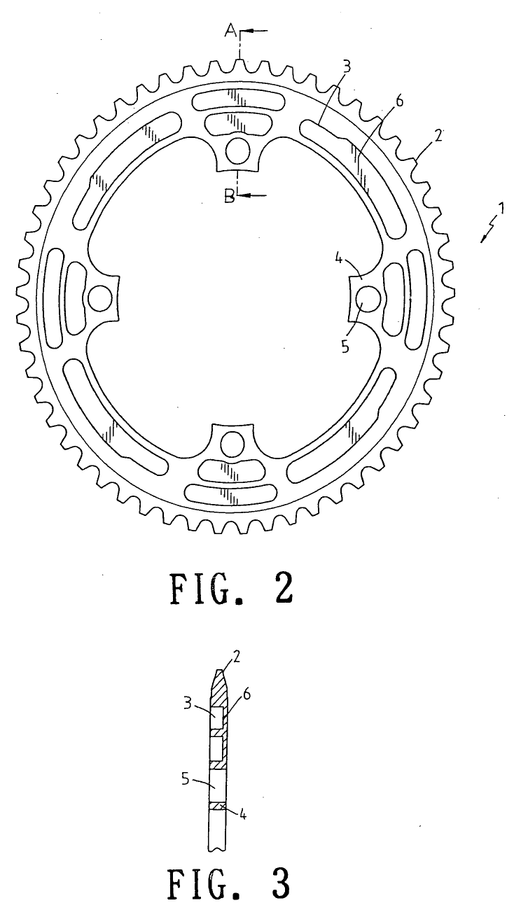

Referring to FIGS. 2 and 3, a bottom of each recess 3 is formed as a stop 6 so as to retain the structural strength of the teeth disk 1. Thus the teeth disk 1 of the present invention is difficult to deform so that the teeth 2 can firmly secure with the chain of a bicycle.

Referring to FIG. 4, the assembly of the present invention is illustrated. In assembly of the teeth disk 1 of the present invention, the surface of the teeth disk 1 with the recesses 3 faces inwards. The ear holes 5 of the ears serve to engage with a crank 7. The crank 7 serves to be connected to a treadle of a bicycle (not shown). The user treads upon the treadle to drive the crank 7 to rotate. The crank 7 is firmly secured to the teeth disk 1 so as to drive the teeth disk 1 to rotate. Furthermore the crank 7 passing through the ear holes 5 can be further combined with other teeth disk for speed change of the bicycle.

It should be noted that the shape of the recess 3 is not confined to those illustrated in the drawing. Other shapes are permissible in the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A teeth disk of a bicycle comprising:
a teeth disk; one surface of the teeth disk having a plurality of recesses which do not penetrate through the teeth disk; and a bottom of each recess is formed as a stop.

2. The teeth disk as claimed in claim 1, wherein each recess has a cambered shape which is arranged near an edge of the teeth disk.

3. The teeth disk as claimed in claim 1, wherein a plurality of teeth are formed along an edge of the teeth disk for engaging to a chain of a bicycle.

4. The teeth disk as claimed in claim 3, wherein the teeth disk has a ring structure with a hollow central hole for being installed with a crank.

5. The teeth disk as claimed in claim 4, wherein an inner edge of the central hole is protruded with a plurality of ears; each ear has an ear hole for combining with a crank.
